(19) United States
(12) Patent Application Publication
(10) Pub. No.: US 2016/0113243 A1
(43) Pub. Date: Apr. 28, 2016

(54) INTERLOCKING PET TOY AND TREAT TRAINER

(71) Applicant: Make Ideas, LLC, La Jolla, CA (US)

(72) Inventors: Keith Mullin, La Jolla, CA (US); Loren Taylor, Chatham, NY (US)

(21) Appl. No.: 14/523,813

(22) Filed: Oct. 24, 2014

(51) Int. Cl. A01K 11/00; A01K 5/00

(52) U.S. Cl. CPC A01K 15/026; A01K 5/00

(57) ABSTRACT

The invention comprises a novel pet toy and treat trainer wherein plastic interlocking pieces simulate vertebrae of perceived prey. Edible discs are integrated alternately with the interlocking vertebrae so that an animal can “catch and consume” the simulated prey. The pieces reside on an inner frame of rope so that the entire toy is pliable. An animal head and tail make up the front and rear interlocking pieces and are also constructed of chewable, but non-edible materials.

### FIELD

The invention relates to a novel pet puzzle toy wherein edible discs are alternated with locking plastic “vertebrae” which simulates anatomical form and function as in actual capture and consumption of prey. Chewable head and tail pieces make up the front and rear interlocking sections of the toy and the center sections reside on a rope spine for flexibility.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet toy and treat trainer wherein plastic interlocking pieces simulate vertebrae of perceived prey. Edible discs are integrated alternately with the interlocking vertebrae so that an animal can “catch and consume” the simulated prey. An animal head and tail make up the front and rear interlocking pieces and are also constructed of chewable, but non-edible materials.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive toy and treat trainer.

### THE INVENTION

### Summary, Objects and Advantages

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

Many dog breeds have an instinct to chase prey or to “herd” other animals. This instinct needs to be provided in some form or an animal will tend to chase or attempt to chew other items such as sofas, or even the household cat. The inventive toy seeks to address that instinct and provide a reward which is safe and healthy for the dog as well as the owner's belonging and other pets.

When a dog chases and captures prey, it will grasp the prey in its mouth. Typically at some point along the prey's spine as that is the easiest mode for a dog to carry prey. Since the inventive toy simulates a prey animal, the dog will believe that it has captured prey by noting that fact in tactile and olfactory terms. The inventive toy and treat trainer triggers and satisfies the sensory elements of that behavioral process.

The inventive toy provides both hard plastic sections and edible soft sections to simulate vertebra and soft tissue. The dog will be provided with the feeling that it has captured real prey via the tactile sensation of grasping the “spine”, and the olfactory sensation emanating from the edible discs.

Further, the toy and treat trainer has a chewable head and tail section which also snap into the interconnecting vertebrae, and provides a visual stimulation to the dog which represents a more authentic animal feel and appearance.

### BRIEF DESCRIPTION OF THE DRAWINGS

The invention is described in further detail by reference to three (3) drawings sufficient in detail to describe the invention in which:

FIG. 1 is a perspective view of the pet toy and treat trainer assembled;

FIG. 2 is a diagrammatic depiction of the pet toy and treat trainer components; and

FIG. 3 is an illustration of a dog holding the pet toy and treat trainer.

### DETAILED DESCRIPTION, INCLUDING BEST MODES OF CARRYING OUT THE INVENTION

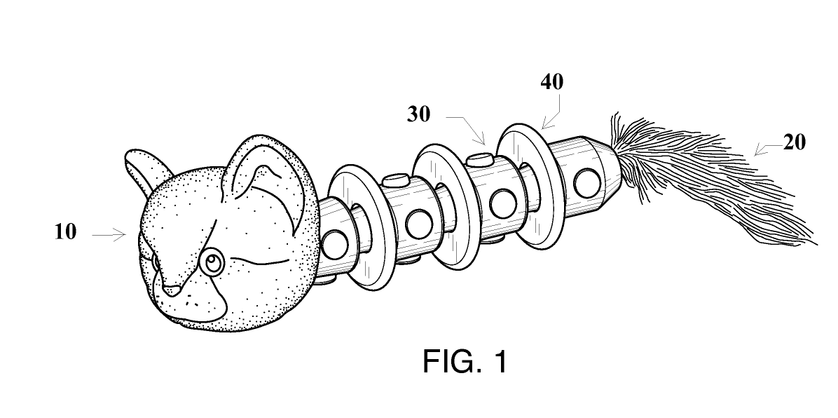

FIG. 1 illustrates the puzzle pet toy and treat trainer assembled. An animal head 10 is attached as a first interlocking piece and may be constructed of plush or rubber. A tail section 20 serves as the end interlocking piece and may be constructed of plastic and a faux fur material to simulate actual prey materials. Hard plastic vertebrae 30 interconnect so as to form the “spine” of the prey. Edible discs 40 fit into indented portions of the plastic vertebrae.

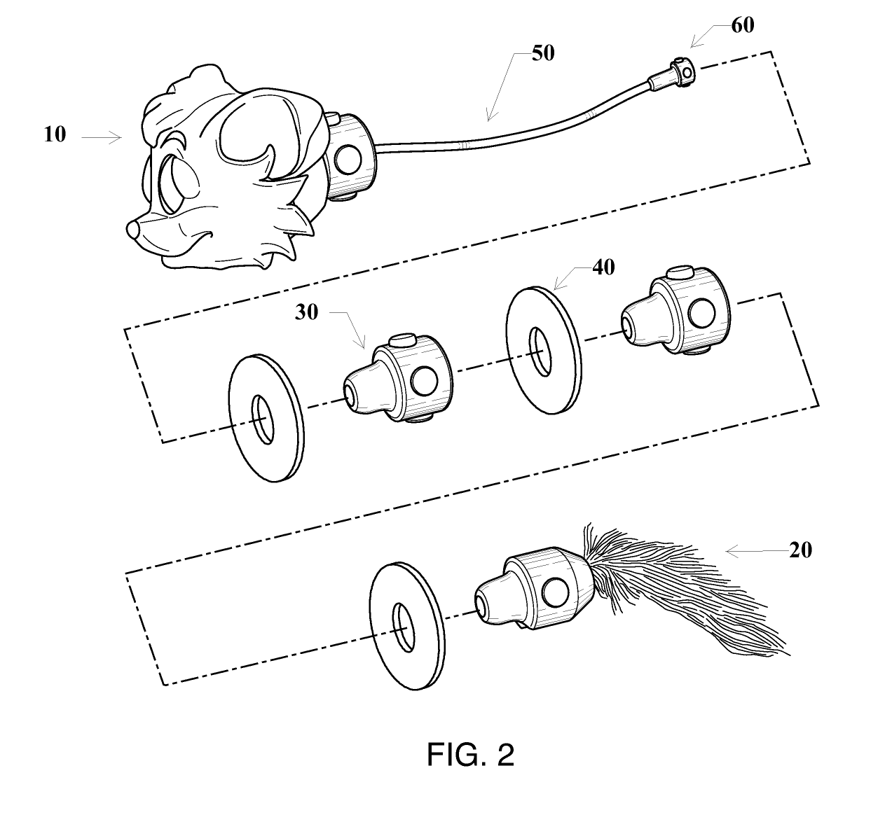

FIG. 2 again shows an animal head 10, in this instance a plush material, and a tail portion 20 which is comprised of faux fur and a hard interlocking plastic vertebrae piece. The plastic vertebrae pieces 30 are shaped so as to interconnect with one another, and are tapered to accommodate the edible rings 40 which a user places onto the toy. Unseen in FIG. 1 is the rope 50 portion which serves as flexible support for all of the interconnected toy pieces. A main interlock piece 60 is located at the end of the rope portion to accept the tail section and allow insertion of edible discs and vertebrae pieces, and ultimately hold assembled pieces of the toy in place.

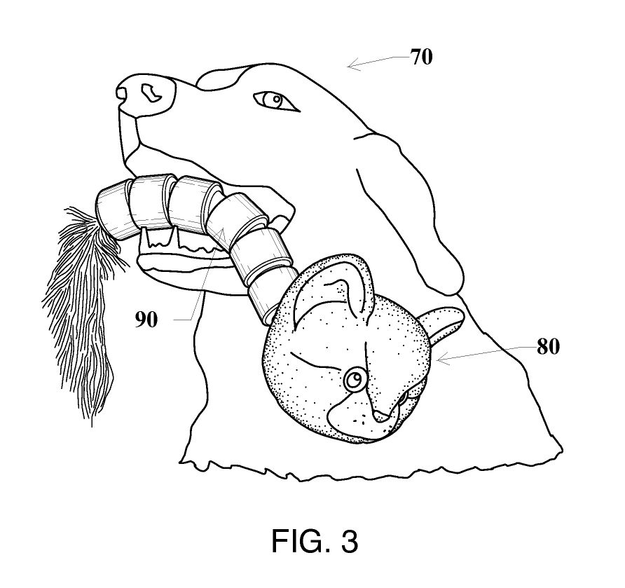

FIG. 3 is an illustration of a dog 70 holding the assembled pet toy and treat trainer 80. The Figure demonstrates the flexible nature 90 of the toy resulting from the pieces being affixed to the inner rope. This assembly makes the toy and treat trainer act in a manner in which actual prey might represent to a dog when it has been captured.

1) An interlocking pet toy and treat trainer comprising;
a) a head portion
b) a tail portion
c) a center spine portion
d) interlocking vertebrae pieces
e) interconnecting edible discs

2) An interlocking pet toy and treat trainer as in claim 1 wherein the head portion is shaped like an animal head and comprised of chewable rubber covered with plush fabric.

3) An interlocking pet toy and treat trainer as in claim 1 wherein the tail portion is comprised of a faux fur material and a plastic vertebrae piece which will interlock with other vertebra pieces and edible discs.

4) An interlocking pet toy and treat trainer as in claim 1 wherein the center spine portion is comprised of rope for flexibility of the toy even when all pieces are interlocked, and wherein a small receiving piece at the end of the rope allows insertion of a vertebrae.

5) An interlocking pet toy and treat trainer as in claim 1 wherein the interlocking vertebrae are comprised of hard plastic and contain holes on one side for receiving other vertebra pieces and are flanged on the other side for placement of edible discs.

6) An interlocking pet toy and treat trainer as in claim 1 wherein the interconnecting discs are comprised of edible material and contain holes in the center for slipping over the flanged portion of the vertebrae to create a string of alternating vertebrae and discs.
